(19) United States
(12) Patent Application Publication
(10) Pub. No.: US 2009/0131287 A1
(43) Pub. Date: May 21, 2009

(54) Inhibiting hydration of shale using a polyol and potassium formate

(76) Inventors: Kevin W. Smith, Houston, TX (US); Taylor C. Green, Houston, TX (US)

Correspondence Address: William L. Krayer, 1771 Helen Drive, Pittsburgh, PA, 15216, US

(21) Appl. No.: 12/291,954

(22) Filed: Nov. 14, 2008

Related U.S. Application Data
(60) Provisional application No. 61/003,427, filed on Nov. 16, 2007.

(51) Int. Cl. C09K 8/60

(52) U.S. Cl. 507/266

(57) ABSTRACT

A substantially nonaqueous composition comprising a polyol and potassium formate is made by removing water from a mixture while heating. The polyol beneficially contains 3-50 hydroxyl groups and may be polyglycerin. The water removed may originate from a solution of one or more of the ingredients, from a condensation reaction of hydroxyl groups, and/or from an esterification reaction of hydroxyl groups on the polyol(s) and the formate groups. The composition is effective for treating shale formations in well drilling to reduce hydration and sloughing of the shale. If, in the course of treating shale formations, the polyol/potassium formate composition mixes with connate or other water, the water may be removed on returning the composition to the surface, and recycled.

### RELATED APPLICATION

This application claims the full benefit of Provisional application 61/003,427 filed Nov. 16, 2007, which is hereby specifically incorporated herein in its entirety.

### TECHNICAL FIELD

In hydrocarbon production from the earth, undesirable hydration of shale formations surrounding wells is inhibited by contacting the formations with a substantially nonaqueous composition comprising a polyol and potassium formate.

### BACKGROUND OF THE INVENTION

The tendency of shale and similar materials to hydrate on contact with well fluids in hydrocarbon producing formations has long been a problem in the hydrocarbon production industry. Hydration of the shale results in sloughing and the enlargement of cavities around the well, which consumes even more fluid and requires the removal of more material from the well. Because hydration of the shale causes swelling of the shale, it may also result in constrictions of the wellbore, causing undesirable changes in pressures, flow patterns, and circulation of fluids. Leaks caused by uneven shale surfaces can cause blowouts and reduced heads, resulting in drastic reductions in drilling efficiency.

Various methods and compositions have been tried in an effort to seal the shale from the aqueous fluids used in drilling, workover, and completion of wells, with varying degrees of success and frustration. Some oil-based and other nonaqueous fluids have been used, but they tend to be expensive and, in many cases, impractical.

The reader may be interested in reviewing Dobson U.S. Pat. No. 6,103,671, Kippie and Foxenburg U.S. Pat. No. 6,784,140, Peterson U.S. Pat. No. 4,780,220, and Hale et al 5,436,227.

### SUMMARY OF THE INVENTION

Our invention includes compositions, methods of making them, and methods of treating a well.

The composition is a mixture of potassium formate and a polyol; water is removed from the mixture to form a substantially nonaqueous liquid. For my purposes, it does not matter whether the acid groups of the formate and the hydroxyl groups of the polyol are more or less esterified prior to use.

Water may be removed from the mixture by heating by any convenient means to facilitate evaporation. If lower molecular weight polyols are present, the heating system may be designed to recapture volatilized polyols while removing the water.

A method of making the substantially nonaqueous potassium formate/polyol composition comprises passing the potassium formate and the polyol through a cavitation device. The cavitation device intimately mixes and heats the materials, at the same time facilitating the separation of water from it by evaporation. However, any effective method of heating the mixture may be used. Advantageously, the reaction will be conducted with means for refluxing or otherwise recapturing volatile polyols and returning them to the heated area, and with means for applying a subatmospheric pressure to the reaction zone. Water is removed from the mixture until it comprises no more than 5% by weight of the composition, which we call substantially nonaqueous.

A further method is a method of treating underground formations by contacting them with the above-described substantially nonaqueous polyol/formate composition. The polyol-formate composition is attracted to the shale or other material liable to hydrate, forming a protective pseudohydrated layer on the shale, which inhibits the hydration of the shale by water, such as may be present in a well fluid, which may otherwise contact it.

Yet another method is a method of treating underground formations by contacting them with the above-described substantially nonaqueous polyol/formate composition, wherein the substantially nonaqueous composition comes into contact and mixes with aqueous fluids placed in the well or present in the surrounding formation, removing the mixture so formed from the well, treating it to remove water therefrom and form a new substantially nonaqueous composition of polyols and potassium formate, and recycling the new composition to the well. In this process also, the water may be removed by passing the mixture through a cavitation device.

### DETAILED DESCRIPTION OF THE INVENTION

A useful specific ratio of ingredients within the broader definition of our novel composition is 25% by weight potassium formate and 75% by weight polyglycerin. Water may be present as a solvent for the potassium formate, or even also with the polyol, when the two principal ingredients are mixed. The hydroxyl groups of the polyglycerin and the acid groups of the potassium formate may esterify fully or partially, or not at all, depending partly on the ratio of the groups to each other and partly on the conditions of the reaction. Heat may encourage esterification, but our invention is not dependent on an esterification reaction. The presence of reacted or unreacted groups of either ingredient (the OH groups of the polyol or the formate groups of the potassium formate) will not adversely affect the inhibition of hydration of the shale.

Water is removed from the composition during or after mixing, or both during and after. Because the objective is to make a substantially nonaqueous fluid, it is desirable to remove 100% of the water, but, as the intimate mixing of the two major components continues, more water may be generated by condensation and/or esterification, and it is acceptable in my invention for the composition to include as much as 5% water by weight when it is actually injected into a well. We consider such a composition containing less than about 5% by weight water to be substantially nonaqueous.

More broadly, our new composition may be stated as a substantially nonaqueous composition comprising a polyol having at least three hydroxyl groups and potassium formate in a ratio effective to inhibit hydration of shale in an underground formation. None, some, or all of the hydroxyl groups of the polyol are esterified with the acid groups of the potassium formate. Water present as a solvent, or formed by condensation and/or esterification reactions, may be removed, such as by evaporation. As water is formed by esterification, it may be removed, again possibly by evaporation, during esterification or after. At the time of introduction into the well, however, the composition should be substantially nonaqueous.

The polyol may contain from 3 to 50 hydroxyl groups. Any polyol, branched or linear, having from 3 to 50 hydroxyl groups may be used, by itself or in mixtures with other polyols. Preferably they will be free of other reactive groups,

Water may be removed from the intermediate or final compositions herein by any convenient method. Evaporation is an effective method, and for this purpose, I may adapt the process disclosed in my U.S. Pat. No. 7,201,225, which is hereby specifically incorporated herein by reference. That is, I may use a cavitation device to heat the fluid and thereby remove water by evaporation.

Our invention includes a composition comprising (a) a potassium formate and polyol mixture consisting essentially of about ht potassium formate and polyol in a weight ratio of 10-40% potassium formate to 60-90% polyol, and (b) water in an amount up to about 5% by weight of the overall composition including the water.

A more specific composition of our invention comprises (a) a potassium formate and polyglycerin mixture consisting essentially of about 22% to about 29% by weight potassium formate and about 71% to about 78% by weight polyglycerin, and (b) water in an additional amount up to about 5% by weight of the overall composition including the water. Since polyglycerin is made by polymerizing glycerine, some polyglycerin compositions may contain significant amounts of monomeric glycerine, and my invention contemplates this by including the glycerine as part of the polyglycerin composition for purposes of the above percentage calculations.

Polyglycerin is readily available commercially. By polyglycerin I mean to include diglycerine and glycerine having a degree of polymerization of 2-10—that is, containing from two to ten units of trihydroxy propane, as well as compositions containing any material amount of polyglycerin which may be predominantly monomeric glycerine.

Following are examples of the preparation of our compositions.

### EXAMPLE 1

Mixtures were prepared of potassium formate and polyglycerin. The potassium formate contained about 24-30% water and the polyglycerin contained about 14% water. The mixtures were made in the proportions (by weight) shown below and heated to drive off water as shown.

| | | Weight loss (%) |
|---|---|---|
| Sample 1 | 75PF:25Pg | 11.0 |
| Sample 2 | 50PF:50Pg | 11.4 |
| Sample 3 | 25PF:75Pg | 9.8 |

Sample 1 was considered to be impractical for use in our process because it was a crystallized paste. Sample 2 was a viscous liquid with suspended crystals, and Sample 3 was a viscous liquid.

### EXAMPLE 2

Again mixtures were prepared of potassium formate containing 24-30% water and polyglycerin containing 14% water. Water was driven off while the mixtures were heated, with the aim of reducing the weight of the mixture about 10%. The following determinations were made:

| | | Wt. | |
|---|---|---|---|
| | | loss (%) | Comments |
| Sample 4 | 60PF:40Pg | 12.1 | Viscous liquid with visible crystals. |
| Sample 5 | 40PF:60Pg | 10.1 | Viscous liquid; no crystals visible. |
| Sample 6 | 30PF:70Pg | 9.9 | Viscous liquid; no crystals visible. |
| Sample 7 | 20PF:80Pg | 10.6 | Viscous liquid; no crystals visible. |
| Sample 8 | 10PF:90Pg | 10.1 | Viscous liquid; no crystals visible. |

Sample 8 contained less than 5% water by weight and was deemed suitable for our invention. Samples 5-7 required additional heating to achieve less than 5% by weight.

Our new well treatment method comprises contacting a formation surrounding a well with such a composition. On contacting shale in the formation by the composition, hydration of the shale will be inhibited, resulting in stabilization and a reduction of sloughing. Our method recognizes that the substantially nonaqueous polyol/potassium formate composition will become contaminated during drilling; it may become diluted by connate water, by other drilling fluid components such as salts, and/or by hydrocarbons present in the well. Since our composition is deposited on the shale and other parts of the formation, it is partially consumed. Our method includes a method of rejuvenating the substantially anhydrous polyol/potassium formate composition by recovering it from the well together with such contaminants, passing it into a cavitation device as described in the above incorporated U.S. Pat. No. 7,201,225, heating the fluid so introduced to evolve water, which may be condensed to provide an aqueous condensate, and returning the polyol and potassium formate to the well. The separation may not be complete—that is, the recycled solution may contain a higher concentration of water that the original, and the solution may contain other salts in addition to the potassium formate, but the solution is nevertheless useful for recycling. A variant of this method includes adding additional polyol and/or potassium formate to the separated solution of polyol and potassium formate. This may be done in a separate mixer or by adding the materials directly to the cavitation device.

We may substitute other alkali metals for potassium in our invention—that is, sodium formate and cesium formate in particular may be used anywhere potassium is mentioned in this description of our invention.

Our invention may be further described as in the following claims:

1. A substantially nonaqueous well treatment fluid effective to inhibit the hydration of shale on contact with said shale comprising a polyol and alkali metal formate

2. The well treatment fluid of claim 1 wherein said polyol contains from 3 to 50 hydroxyl groups.

3. The well treatment fluid of claim 1 wherein said alkali metal formate is potassium formate and comprises about 10% to about 40% by weight of the total of said alkali metal formate and said polyol.

4. The well treatment fluid of claim 3 wherein said potassium formate comprises about 22% to about 29% by weight of the total of said potassium formate and said polyol.

5. The well treatment fluid of claim 1 wherein said polyol is polyglycerin.

6. Method of making a well treatment fluid comprising (a) forming a mixture of a polyol, alkali metal formate, and water, (b) heating said mixture, and (c) removing water from said mixture to form a substantially nonaqueous liquid.

7. Method of claim 6 wherein said polyol is polyglycerin.

8. Method of claim 6 wherein said substantially nonaqueous liquid contains no more than 5% water by weight.

9. Method of claim 6 wherein said polyol contains from 3 to 50 hydroxyl groups.

10. Method of claim 6 including esterifying at least some of the acid groups of said alkali metal formate with at least some of the hydroxyl groups of said polyol.

11. Method of claim 6 wherein said mixing is conducted in a cavitation device.

12. Method of claim 10 including removing water formed during said esterification, and wherein said substantially nonaqueous liquid contains up to about 5% water.

13. Method of claim 6 wherein said polyol condenses when heated to form a higher molecular weight polyol and water, and including (c) removing said water from said mixture.

14. Method of treating a shale-containing formation in a well comprising contacting said formation in said well with a substantially nonaqueous fluid comprising a mixture of a polyol and alkali metal formate.

15. Method of claim 14 wherein said polyol is polyglycerin.

16. Method of claim 14 wherein said polyglycerin has a degree of polymerization of 2-10.

17. Method of claim 14 wherein said polyol contains from 3 to 50 hydroxyl groups.

18. Method of claim 14 wherein said nonaqueous fluid contacts and mixes with aqueous fluid in said well, thereby forming a mixture of said nonaqueous fluid and said aqueous fluid, and including the steps of (a) removing said mixture from said well (b) removing water from said mixture, thereby forming a more concentrated fluid, and (c) recycling said more concentrated fluid to contact said formation in said well.

19. Method of claim 18 wherein said water is removed from said mixture at least partly by passing said mixture through a cavitation device.

20. Method of claim 18 including adding at least one of additional polyol and additional alkali metal formate to said more concentrated fluid prior to recycling.
